(19) United States
(12) Patent Application Publication
(10) Pub. No.: US 2005/0216366 A1
(43) Pub. Date: Sep. 29, 2005

(54) METHOD AND SYSTEM FOR CONTROLLING SPARE PARTS INVENTORY WITHIN A MANUFACTURING PLANT

(75) Inventors: Ridge Vincent, Tecumseh, Ontario (CA); Rob McLean, Harrow, ON (CA); Craig Bitel, Pleasant Ridge, MI (US); Michael Kokavec, Lasalle, Ontario (CA); Warren Schwanky, Brighton, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD MOTOR COMPANY, Dearborn, MI (US)

(21) Appl. No.: 10/708,510

(22) Filed: Mar. 9, 2004

(51) Int. Cl. G06F 17/60

(52) U.S. Cl. 705/28

(57) ABSTRACT

A method and system for controlling spare parts inventory within a manufacturing plant by identifying and locating spare parts in the manufacturing plant. Signals representative of a spare parts search request from a user are transmitted to a base station. The base station processes the signals with inventory data to obtain a search result. The search results represent identification location data for each unit in the spare parts search request and also an available quantity of the spare part units relative to the quantity of spare parts units needed for the desired manufacturing levels.

### BACKGROUND OF INVENTION

1. Field of the Invention

The present invention relates to inventory control systems for use in manufacturing plants having multiple workstations at different locations in the plant, and in particular, to computer-implemented inventory control systems which permit control of spare parts inventory by identifying and locating spare parts in the manufacturing plant.

2. Background Art

Manufacturing plants relate to plants where a product is made, manufactured, or otherwise assembled. Typically, most plants include a number of machines which work alone or in combination with other machines to produce the product.

The machines can be, and typically are, arranged into workstations for operation by a user. In automotive manufacturing, for example, the workstations can be arranged into a assembly line for manufacturing a vehicle.

The machines have a tendency to periodically brake down over time. These break downs can be costly to the manufacturer, especially if the break down shuts down an assembly line. The plants maintain spare parts inventories to provide spare parts for repairing the broken down machines.

Many manufacturing plants have quotas or some other performance criteria for the users. If the machine breaks down and the user has to wait too long for a spare part, the user is unlikely to make the performance quota. The break down may not be the fault of the user, but the user is nevertheless blamed for missing their performance quota.

The users have a tendency to stockpile excessive numbers of spare parts at their workstation. The stockpile provides the user with quick access to spares they may need for repairs.

The stockpiling of spare parts tends to produce an inefficient allocation of the plant resources. This forces the plant to purchase excessive numbers of spare parts, which is cost prohibitive.

In the past, to limit the stock piling of spare parts, the users were required to check the parts out from a spare parts crib. In this manner, an operator of the crib could, in theory, control the flow of spare parts and limit the users from creating personal stock piles.

The crib method, though helpful in some respects, tends to adversely affect Lean Manufacturing. In Lean Manufacturing, it is desirable to maintain an optimal amount of spare parts at the places where the spare parts are needed.

### SUMMARY OF INVENTION

It is, therefore, a desire of the present invention to facilitate controlling spare parts inventory within a manufacturing plant to limit the stockpiling of personal spare parts inventory.

One aspect of the present invention relates to a computer-implemented method for controlling inventory in a manufacturing plant having a number of work stations at different locations in the plant.

The method begins by associating each unit of the spare parts inventory with identification, location, and operational needs data. The data generally comprises data which provides details regarding the identification and location of the spare parts as well as the number of parts needed for desired plant operations.

Once the data is associated with the spare parts, the data is stored at a common base station. The data stored at the base station is referred to as inventory data and represents the units of inventory according to their identification, location, and operational needs data.

The location data can include a plant name, a department name, a workstation location, an operator name, and a drawer position. The identification data can include keywords, a part description, a remark, a manufacturer part number, a vendor part number, a bar code number, a vendor name, a vendor contact link, a unit cost, a critical designation, and a blue print number. The operational needs data represents a quantity of spare part units needed for desired plant manufacturing levels.

Users can locate parts within the manufacturing plant by transmitting signals representative of a spare parts search request to the base station. A graphical user interface having a number of fields can be provided on one or more computer terminals in the plant. The graphical user interface can receive instructions from the user and transmit the signals needed for the search request to the base station. Preferably, the user is permitted to search for spare part according to each of the aforementioned identification and location data.

The base station receives the search signals from the graphical user interface for processing with the inventory data. The processing preferably occurs in the base station and produces a search result representing the inventory data for each unit in the spare parts inventory matching the spare parts search request.

In addition, the search results preferably also include an available quantity of the spare part units displayed relative to the quantity of spare part units needed for the desired manufacturing levels. This information can be vital for controlling whether new spare parts are purchased or whether the plant already possesses spare parts which can be retrieved from within the plant. Optionally, the search result can be based on multiple plants located remotely from each other so that the user can request spares from the other plants rather than purchasing new spares.

The search results are transmitted from the base station to the computer for graphical display to the user. The search results, preferably, are displayed in a user-friendly manner on the graphical user interface.

In one embodiment of the present invention, the graphical user interface provides a first screen indicating all the matching spare parts, including at least a portion of the inventory data. The user can then select a link in the graphical user interface to view the remaining the inventory data. In this manner, the user can search for spare parts and locate the spare parts for use in repairing their machine.

When the parts are used, the base station can automatically update the spare parts inventory. In one embodiment of the present invention, the inventory is updated by the user returning a bar code card to a drop box. The bar code card is then scanned and its identification and location data is transmitted to the base station for updating the spare parts inventory data. The spare parts inventory is then automatically decremented.

Usage reports can be automatically generated to track and monitor the usage of spare parts. The usage reports can include a parts needed report, an excessive parts list, a historical parts list, and a critical parts lists. These usage reports are automatically generated by processing at the base state and automatically updated as parts are used. This information can be helpfully in managing the spare parts inventory, especially with tracking the purchasing of new spare parts.

### BRIEF DESCRIPTION OF DRAWINGS

FIG. 1 illustrates a system for controlling spare parts inventory in accordance with the present invention;

FIG. 2 illustrates a graphical user interface to facilitate associating inventor data with spare parts inventory in accordance with the present invention;

FIG. 3 illustrates a graphical user interface to facilitate submitting search requests in accordance with the present invention;

FIG. 4 illustrates a graphical user interface to facilitate displaying search results in accordance with the present invention;

FIG. 5 illustrates a graphical user interface to facilitate displaying detailed search results in accordance with the present invention; and

FIG. 6 illustrates a graphical user interface to facilitate selecting spare parts inventory usage reports.

### DETAILED DESCRIPTION

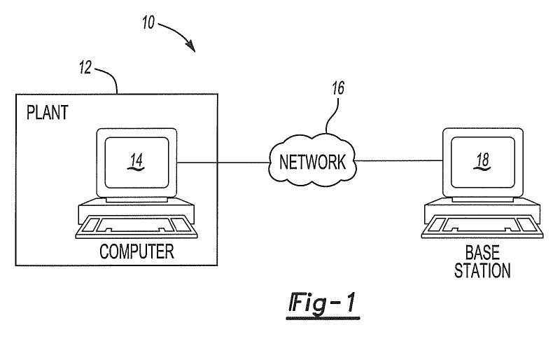

FIG. 1 illustrates a system 10 in accordance with the present invention for controlling spare parts inventory. The system includes manufacturing plant 12, computer 14, network 16, and base station 18.

Manufacturing plant 12 generally relates to an automotive manufacturing plant having a number of machines arranged into work stations. The manufacturing plant, and the present invention, however, are not limited to automotive manufacturing.

Computer 14 relates to a common laptop or desktop computer which is located within plant 12. It can also be a personal data assist or any other portable device which is capable of electronic operation in accordance with the present invention.

Computer 12 communicates with base station 18 by transmitting communications signals over network 16. Base station 18 is typically a server or data base type system which is capable of storing information, processing the stored information in response to search requests, and generating transmissions to the network.

Network 16 can comprises any network arrangement, including an intranet or an internet arrangement. In the intranet arrangement, the same network connects computer to base station. This configuration can be used for single plant spare parts inventory control. In the internet arrangement, separate networks at different plants communicate with base station. This configuration can be used for multiple plant spare parts inventory control.

Manufacturing plant 12 includes a number of machines for doing work. The machines are arranged into workstations at different locations of plant 12. The workstations can include multiple machines. A user is required to operate the workstation and the machines therein. The machines periodically require spare parts when broken down.

The machines have a tendency to brake down over time. The break downs can be costly to the manufacturer, especially if the break down shuts down an assembly line. To limit the down time, spare parts can be kept at plant 12 to repair the broken down machines.

The users, however, have a tendency to stockpile the spare parts, producing an inefficient allocation of the plant resources. Because the users are stockpiling the parts, plant 12 is forced to purchase excessive numbers of spare parts. This is cost prohibitive and a problem.

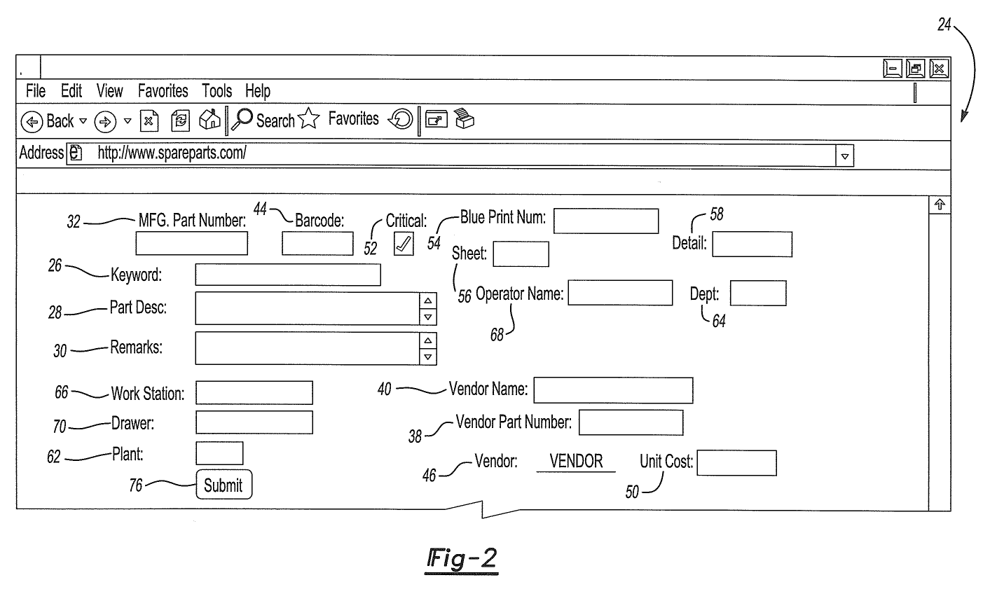

FIG. 2 illustrates graphical user interface 24 to facilitate transmitting inventory data to base station. The inventory data relates to identification, location, and operational needs data which is entered for each part and communicated to base station 18. The stored data can then be accessed by base station 18 in response to a search request to search for spare parts.

Preferably, graphical user interface 24 is a software program residing on computer. Computer 14 can receive the data and transmit it to base station 18 for storage. Optionally, however, the data could be transmitted in a spreadsheet or manually entered into base station 18.

Graphical user interface 24 includes a number of fields which can receive alphanumeric characters to facilitate identify and locating the spare parts.

Guidelines can be provided to assist with determining the appropriate data. In particular, a common set of rules could be used to assist with communalizing the different data so that the same data are used for the similar parts.

The identification data can include keywords 26, a part description 28, a remark 30, a manufacturer part number 32, a vendor part number 38, a vendor name 40, a bar code number 44, a vendor contact link 46, a unit cost 50, a critical designation 52, and a blue print number 54 including sheet 56 and detail 58.

Keyword data 26 is the commonly referred to name for the spare part in the industry. Part description data 28 is a longer textual description of the part. Part description data 28 can be an industry standard description or other user provided description.

Remark data 30 includes a textual description which, in comparison to the part description, relates to other information which may be less descriptive of the part, but more descriptive of other relevant information. Commonly, remark data 30 relates to special care instructions for the part or other information which may be relevant to users seeking to use the part.

Vendor part number data 38 is an alphanumeric description for the part assigned by the vendee. Additionally, manufacture part number 32 may also assign. Both part numbers 32, 38 could be associated with the same part.

Bar code number 44 is also an alphanumeric description for the part which is assigned to the identification data assigned the part. Bar code number 44 changes for each part. Blue print data 54 indicates a corresponding blue print or computer aided drawing for the part, including sheet 56 and detail 58. Unit cost data 50 indicates the cost of the spare part. Typically, the spare parts are determined from a blanket purchase order.

Vendor name 40 indicates the vendor. Vendor link 46 is typically an embedded use address which takes the user to a separate pop-up vendor window (not shown). The vendor window indicates contact information for contacting the vendor, and optionally, whether a blanket purchase order is available for the spare part.

The user can use the blanket purchase order to purchase new parts. Preferably, the purchasing of new parts is an automated process where the request is electronically sent to the manufacturer from actuation of a button or other electronic means in the vendor window.

Critical designation 52 is provided to indicate whether the spare part is critical to plant operations. In some case, it is vital to have some spares always on-hand due to the necessity of these parts in the event of a breakdown. These parts receive a checkmark.

Location data, like the identification data, can be any combination of alphanumeric characters. The location data is typically customized by the user entering the information. In other words, rather than using a coordinate system, or other arbitrary methodology, the users at each plant enters in the location data according to the common designations used in the plant. In this manner, different plants can have different descriptions, but the personnel at each plant should have an easier time locating the parts. However, a coordinate system could similarly be used.

The location data can include a plant name 62, a department name 64, a workstation name 66, an operator name 68, and a drawer position 70. Plant name 62 indicates a plant in which plant 62 is located. This data is especially helpful if multiple plants are searched for spare parts.

Department name 64 indicates the department within the plant where the part is located. Workstation name 66 indications the workstation where the part is located within department 64.

Operator name 68 indicates the name of the operator (user) working at the workstation having the part. This person is typically the key contact for locating the part, i.e., the person stockpiling the part. Drawer position 70 indicates in which cabinet drawer the part is located. This is helpful as many of the spare parts are stored in cabinets at the workstations.

To further assist with controlling the spare parts inventory, operational needs data is also stored at base station 18. The operation needs data represents a quantity of spare part units needed for desired plant manufacturing levels.

This data typically comprises a minimum and maximum value for the part relative to the operational needs of the particular plant. The values are determined by supervisors based on past usage and needs. This data is typically entered separately to base station 18.

The operational needs, as described in more detail below, can be used to compare the actual spare parts inventory levels against the desired spare parts level (i.e. minimum/maximum) to determine whether a part should be purchased or retrieved from elsewhere in the plant.

Submit button 76 is provide to initiate transferring the data to base station 18.

The inventory data is transferred, i.e., in putted to base station when parts are removed from the crib for dispersal to the users. In accordance with the present invention the crib is merely a receiving point to receive the spare parts from the vendors. Once received, most of the parts are preferably dispersed to various workstation to support Lean manufacturing. Base station 18 automatically increments the available quantity of the spare part based on the inputted data.

The inventory, i.e., the location identification, no operational needs data, is stored on the base station for subsequent use in searching for spare parts and for managing spare parts inventory. In particular, users, such as skilled trades users, can use the computer to search for and locate spare parts. Also, users, such as a supervisor, can manage the spare parts inventory by using the computer to retrieve usage reports and other historical information on spare parts, as described below in more detail.

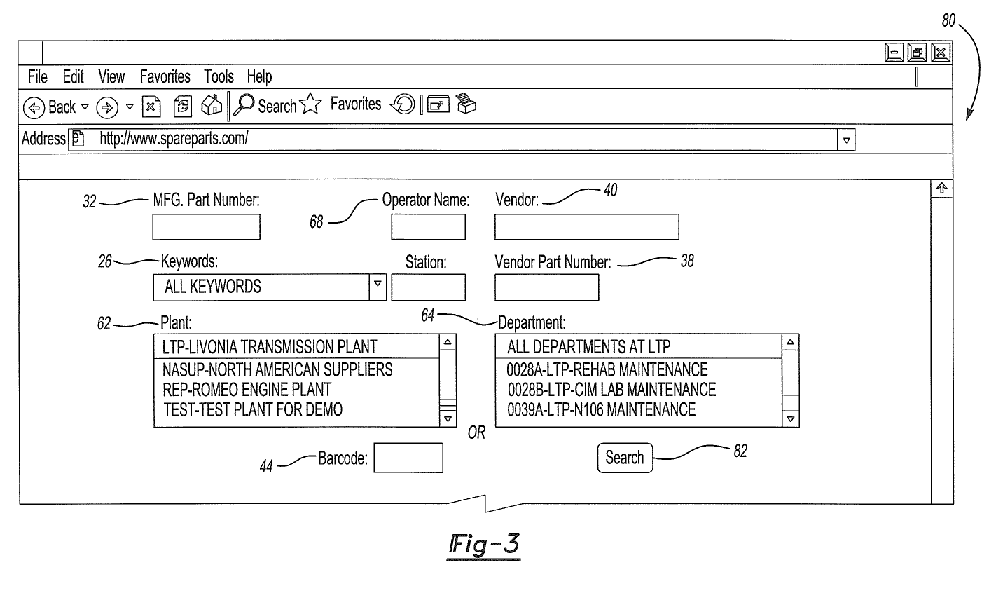

FIG. 3 illustrates graphical user interface 80 to facilitate transmitting a search request to base station 18. A number of fields can be provided in graphical user interface for receiving instructions from the user. Preferably, the user is permitted to search for spare parts according to each of the aforementioned identification and location data.

The user need only enter data for one or more of the data fields. The search can then be transmitted to base station by actuating search button 82. Graphical user interface then generates corresponding signals which are communicated over network to base station. The search signals are processed at base station with the inventory data and the operational needs data to generate the search results.

The processing preferably occurs in the base station and produces a search result representing the identification, location data, and operational needs data for each unit in the spare parts inventory matching the spare parts search request.

As shown, drop-down and scroll-down menus are optionally provided for the keyword data, the plant data, and the department data. These menus provide a list of commonly used search criteria. The menus can also be coordinate with the address of computer 14 so that the menus automatically pull up the menus for plant 12 from which the search is originating. This process is referred to as dynamic addressing.

The search results can be used for controlling whether new spare parts are purchased or whether the plant already possesses spare parts which can be retrieved from within the plant. The search result can be based on multiple plants located remotely from each other so that the user can request spares from the other plants rather than purchasing new spares.

The search results are transmitted from the base station to the computer for graphical display to the user. The search results, preferably, are displayed in a user-friendly manner on the graphical user interface. In this manner, the user can search for spare parts and locate the spare parts for use in repairing their machine.

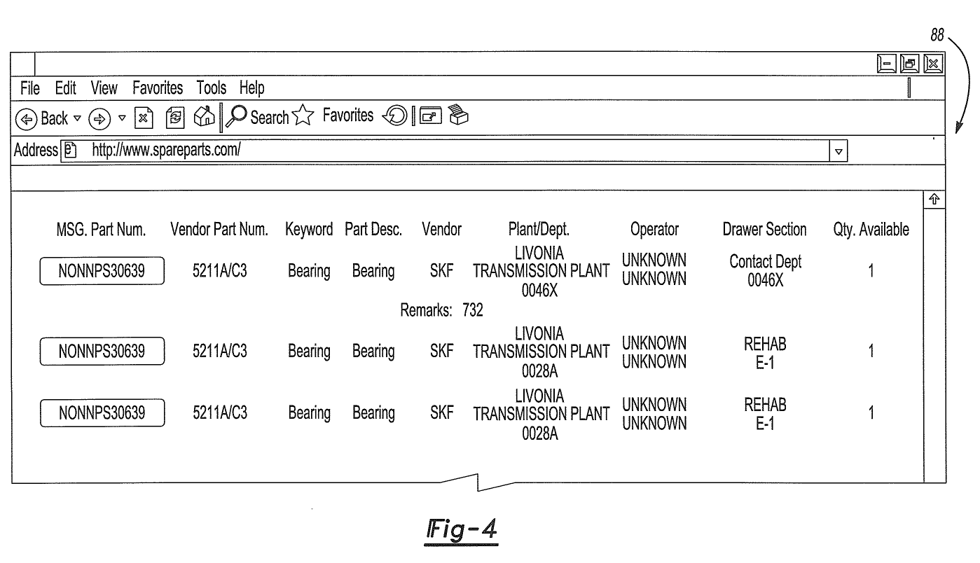

FIG. 4 illustrates graphical user interface 88 indicating the search results. A number of different parts are listed, as many parts include similar data which may match the search criteria. Often, multiple spare parts will be available from different locations within the same plant.

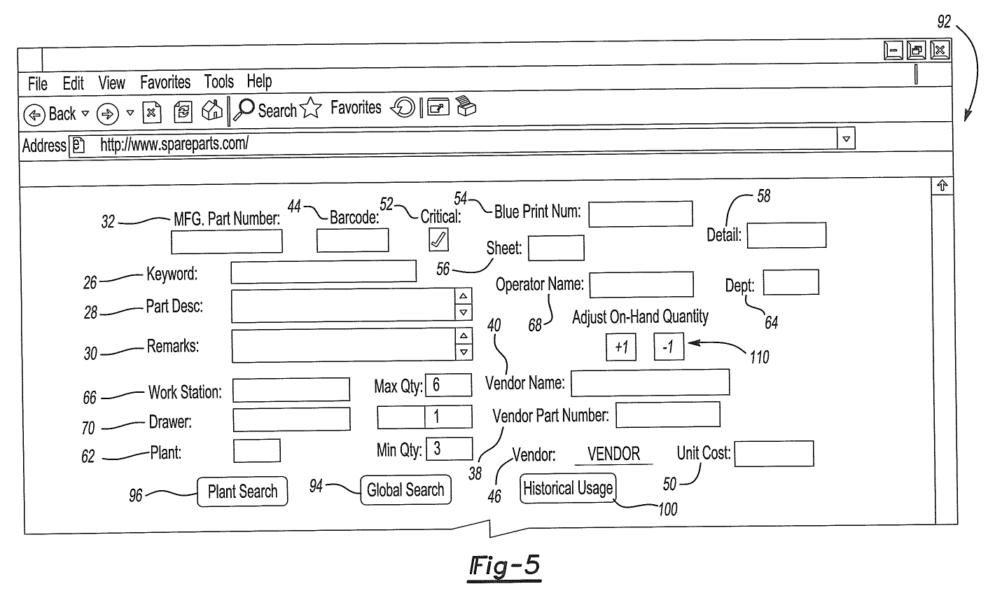

This view is at a relatively high level. The user can select a link in the graphical user interface to view graphical user interface 92, which includes the identification, location, and operational needs data in more detail, as shown in FIG. 5.

In FIG. 5, more data is provided for the selected part. Preferably, all the available data for the spare part is shown. In some case, however, security clearances may be required to view some of the data. The security clearance can be determined based on a user login name or other password system.

Generally, the security clearancing is done to limit the location data to key contact information such as the operator are, and not the detailed location data, to prevent unauthorized takings of the spare parts.

The user generally desires to locate parts from their own plant. Accordingly, the initial search is usually limited to the plant originating the search. Global search button 94 is provided to conduct a broadening search without having to return to a previous page.

A global search result is similar to the results shown in FIG. 5, except parts from a number of plants are included. However, the user could select all or multiple plants from the drop-down menus in FIG. 4. Plant search button 96 is provided returning to the plant search page from a global search page.

The global search functionality provides additional Lean Manufacturing advantage within a multiple plant manufacturing system. Rather than storing spare parts for dispersal to each plant, the global search capabilities allows all the spare parts to be dispersed throughout the system. The global search is used if parts are needed by any plant in the system. This supports Lean Manufacturing in that the spare parts levels are as low as possible and dispersed where needed, and just in time delivery is provided by the global search.

Usage report button 100 is provided to access reports which are automatically generated by base station for the selected spare parts. These reports can be automatically generated to track and monitor the usage of spare parts.

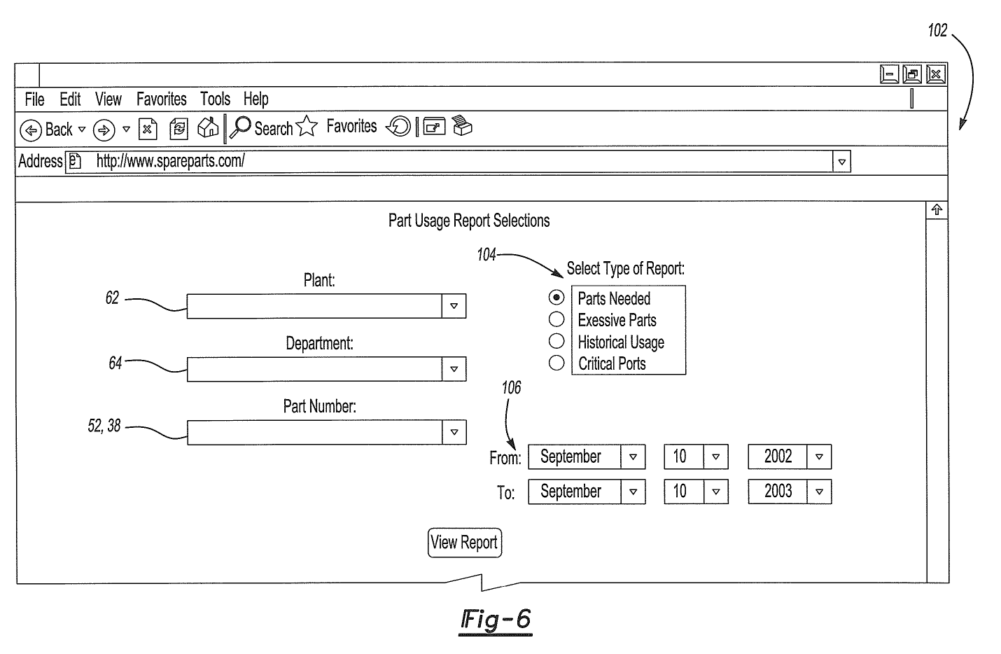

FIG. 6 illustrates graphical user interface 102 for selecting a usage report. The usage reports can include a parts needed report, an excessive parts list, a historical parts usage list, and a critical parts lists.

Graphical user interface 102 is automatically populated with the spare parts data from the preceding interface 92, including the plant data, the department data, and the part number data. The user can change the data as desired. The user then selects the desired report from report selector 104 and time period from period selector 106. The reports are then generated.

The historical parts usage report is typically generated by selecting the plant, department, and part number data. The historical parts usage report then lists the usage for that part over the selected time period. Optionally, the part number data can be left blank, resulting in the report listing the usage level for all the spare parts in the selected plant and department.

The parts needed report is typically generated by selecting the plant and department data and leaving the part number data blank. This report list all the spare parts for the selected plant and department which have available quantities which are less than the desired minimum quantity.

The excessive parts list is typically generated by selecting the plant and department data and leaving the part number data blank. This report list all the spare parts for the selected plant and department which have available quantities which are greater than the desired maximum quantity.

The critical parts report is typically generated by selecting the plant and department data and leaving the part number data blank. This report list all the spare parts for the selected plant and department which have are deemed critical to plant operations. This report is generated, typically by a supervisor, to period check on the available quantity of the critical spare parts to insure adequate supplies are on-hand.

Optionally, the usage reports can be automatically generated by processing at the base state and automatically updated as parts are used. In this case, links could be separate provided for accessing the reports without having to enter the data shown in FIG. 6. The usage report information can be helpfully in managing the spare parts inventory, especially with tracking the purchasing of new spare parts.

When the parts are used, the base station can automatically update the spare parts inventory. This can be done by the user decrementing the available quantity by selecting decrement button 110 from FIG. 5.

In addition, an automated process can be set up based on the bar code cards. The automated process simply requires the user to drop off the bar code card in a dropbox. The bar code card is then scanned and its corresponding inventory data is transmitted to the base station. The spare parts inventor is then automatically decremented. This process can be especially helpful when users are unable or unwilling to make changes through the graphical user interface.

While the best mode for carrying out the invention has been described in detail, those familiar with the art to which this invention relates will recognize various alternative designs and embodiments for practicing the invention as defined by the following claims.

1. A computer-implemented method to facilitate controlling spare parts inventory within a manufacturing plant, the manufacturing plant having a number of workstations at different locations in the plant, the method comprising:
associating each unit of inventory with identification data, a location data, and operational needs data, the operation needs data representing a quantity of spare part units needed for desired plant manufacturing levels, storing inventory data at a common base station, the inventory data representing units of spare parts inventory according to their identification, location, and operational needs data;
transmitting signals representative of a spare parts search request from a user to the base station;
processing the signals with the inventory data to obtain a search result, the search result representing the identification and location data for each unit in the spare parts search request and also an available quantity of the spare part units relative to the quantity of spare part units needed for the desired manufacturing levels; and
transmitting the search results to the user.

2. The method of claim 1 further comprising decentralizing the spare parts inventory by dispersing the spare parts throughout the different workstation locations in the manufacturing plant, locating and retrieving the dispersed spare parts by transmitting search requests to the base station.

3. The method of claim 2 wherein dispersing the spare parts comprises checking out the spare parts from a plant crib, the identification and location data associated with the spare parts when checked out.

4. The method of claim 1 further comprising associating vendor data with each spare part, the vendor data stored with the inventory data for representing vendors to be used for purchasing new spare parts, the search result also representing the vendor data.

5. The method of claim 3 further comprising purchasing new spare parts through a blanket purchase order represented in the vendor data.

6. The method of claim 1 further comprising associating key contact data with each spare part, the key contact data stored with the inventory data for representing persons within the manufacturing plant responsible for controlling removal of spare parts from the work stations associated with each location data, the search result also representing the key contact data.

7. The method of claim 1 further comprising processing in the base station the inventory data for automatically generating a usage report.

8. The method of claim 7 wherein generating the usage report comprising representing parts needed, the parts need representing only the spare parts having available quantities which are less than the quantity needed for the desired plant manufacturing levels.

9. The method of claim 7 wherein generating the usage report relates to an excessive usage, the excessive usage representing only the spare parts having available quantities which are greater than the quantity needed for the desired plant manufacturing levels.

10. The method of claim 7 wherein generating the usage report relates to a historical usage, the historical usage representing usage of the spare parts relative to the operational needs data and a historical period of time.

11. The method of claim 7 wherein generating the usage report relates to a critical parts list, the critical parts list representing spare parts critical to the operational needs data.

12. The method of claim 1 further comprising retrieving a spare part from one of the workstations based on the location data, returning a bar code card to a drop-box for indicating retrieval of the spare part, the bar code card including the identification and location data for the spare part, scanning the bar code card and transmitting signals representing bar code data to the base station, processing the signals for automatically updating in the base station the available quantity of the retrieved spare part.

13. The method of claim 1 further comprising storing inventory data for multiple manufacturing plants, transmitting signals representing a plant or global search, the plant search restricted to the plant originating the signals and spare parts located therein, the global plant search including each of the multiple manufacturing plants and spare parts located therein.

14. The method of claim 1 wherein the location data includes a plant name, a department name, a workstation location, an operator name, and a drawer position.

15. The method of claim 14 further comprising transmitting a signal representing a security data with the search request, the security data representing which location data are represented in the search result.

16. The method of claim 1 wherein the identification data includes a keyword, a part description, a remark, a manufacturer part number, a vendor part number, a bar code number, a vendor name, a vendor contact link, a unit cost, a critical designation, and a blue print number.

17. The method of claim 1 further comprising providing multiple computers within the manufacturing plant, the multiple computers usable by each plant employee for searching for spare parts, each computer includes a graphical user interface to facilitate transmitting and receiving signals from the base station and also to display the search results to the user.

18. A computer-implemented method to facilitate controlling spare parts inventory within a manufacturing plant, the manufacturing plant having a number of work stations at different locations in the plant, the method comprising:
storing inventory data at a common base station, the inventory data representing units of spare parts inventory according to identification, location, and operational needs data;
transmitting signals representative of a spare parts search request from a user to the base station;
processing the signals with the inventory data to obtain a search result, the search result representing the identification and location data for each unit in the spare parts search request and also an available quantity of the spare part units relative to the quantity of spare part units needed for the desired manufacturing levels; transmitting the search results to the user; and
automatically updating in the base station the available quantity of spare parts by retrieving a spare part from one of the workstations based on the location data, returning a bar code card to a drop-box for indicating retrieval of the spare part, the bar code card including the identification and location data for the spare part, scanning the bar code card and transmitting signals representing bar code data to the base station, processing the signals for automatically updating in the base station the available quantity of spare parts.

19. A computer-implemented method to facilitate controlling decentralized spare parts inventory within a manufacturing plant, the manufacturing plant having a number of work stations at different locations in the plant, the method comprising:
decentralizing the spare parts inventory by dispersing the spare parts throughout the different workstation locations in the manufacturing plant to promote lean manufacturing by making the spare parts available where needed without requiring a crib system to checkout the spare parts;
storing inventory data at a common base station, the inventory data representing units of spare parts inventory according to identification, location, and operational needs data;
transmitting signals representative of a spare parts search request from a user to the base station;
processing the signals with the inventory data to obtain a search result, the search result representing the identification and location data for each unit in the spare parts search request and also an available quantity of the spare part units relative to the quantity of spare part units needed for the desired manufacturing levels; and
transmitting the search results to the user.

20. The method of claim 19 wherein dispersing the spare parts comprises initially checking out the spare parts from a plant crib, the plant crib for receiving the spare parts from the vendor, the identification and location data being associated with the spare parts when checked out.
